(19) United States
(12) Patent Application Publication
(10) Pub. No.: US 2023/0078798 A1
(43) Pub. Date: Mar. 16, 2023

(54) DISTRIBUTED DIGITAL ECOSYSTEM ADAPTING MULTIPLE INFORMATION AND CURRENCY-RELATED TECHNOLOGICAL RESOURCES

(71) Applicants: Paul Hung Nguyen, Taylorsville, UT (US); Maximus Robert Dayton, Salt Lake City, UT (US); Vanarick Panh, Salt Lake City, UT (US)

(72) Inventors: Paul Hung Nguyen, Taylorsville, UT (US); Maximus Robert Dayton, Salt Lake City, UT (US); Vanarick Panh, Salt Lake City, UT (US)

(21) Appl. No.: 17/475,285

(22) Filed: Sep. 14, 2021

(51) Int. Cl. G06Q 20/36; G06Q 20/06

(52) U.S. Cl. CPC G06Q 20/3678; G06Q 20/065

(57) ABSTRACT

A method and system for providing a distributed, digital ecosystem incorporating a plurality of platforms, including merchant processing, accounting, POS, CRM, marketing, analytics, currency exchange, and others. The distributed, digital ecosystem is remotely accessed by a data processing device (DPD) under the control of a user, typically on a WAN. Applications incorporated into the ecosystem are installed on a remote DPD, or server, which is shared in all instances via video streaming with the user such that installation of applications directly on the user's DPD is unnecessary, providing said user with the ability to access the ecosystem remotely from any DPD and any location, even when DPDs are lost or destroyed.

### BACKGROUND

### Field of the Invention

This invention relates to a method and system for management of a marketplace operations online and more particularly relates to a method and system for providing a social media, marketing, and digital ecosystem online.

### Description of the Related Art

Modern ecommerce ecosystems typically draw on technologies such as mobile commerce, Internet marketing, online transaction processing, electronic data interchange, and automated data collection systems to provide a single gateway to multiple business attempting to manage their business affairs online.

Social commerce is a subset of electronic commerce that involves using social media (online media supporting social interaction), and user contributions to assist in the online buying and selling of products and services, including customer ratings and reviews, user recommendations and referrals, social shopping tools (sharing the act of shopping online), forums and communities, social media optimization, social applications and social advertising.

A social media ecosystem is a system formed by an interaction of a community of social media users with their environment including the Internet and social media sites such as Facebook®, Instagram®, Twitter® and others. Participants in the ecosystem publish, maintain, and upload electronic content. They may rate and read information and engage in conversations about products and services via the various social media platforms.

There are many problems associated with providing cooperative digital ecosystem, including brining various functions and platforms into a single ecosystem, such as accounting, banking, payment function, communication, marketing and others, which information may be adapted and customized to the particular function or role of a user, such as a merchant or consumer.

Typical ecosystems in the art are adapted to meet the limited needs of mainly merchants, but not merchants and consumers both. These ecosystems do not include functions which assist consumers, particularly those relying on mobile phones.

Because ecosystems known in the art cater primarily to businesses and merchants, there are not ecosystems which function optimally for consumers, particularly on mobile devices containing multiple applications in computer-readable memory which must be loaded each time the phone is lost, upgraded or replaced; or when the operating system is upgraded. These applications on the phone are configured for the particular software-hardware configurations. Quite often, the applications become obsolete as an operating system becomes older and stop functioning altogether or stop functioning properly. Individual users of the phones often lack the technical expertise to update the operating system, firmware, BIOS, and applications themselves. As phones become more-and-more dependent on data transfer, this method of updating and maintaining user-needed applications on phones becomes more-and-more antiquated and nonoptimal.

One problem is how to create cooperative marketplaces in a social media ecosystem. Another problem is how to optimize sales and purchasing model to that benefits everyone on the social media ecosystem. It is desirable to solve some of the problems associated with creating cooperative marketplaces in social media ecosystems.

There exists a need in the art for an ecosystem which can customized by an end user to incorporate multiple platforms, which platforms may be in the form of mobile phone apps. There is a need for an ecosystem which is maintained and updated on the server side rather than the user side such that it can be accessed anywhere at any time by the user without reconfiguration, including after the loss or replacement of a computing device. including POS, accounting, merchant-processing, banking, analytics, marketing and/or CMS. It is an object of the present invention to cure these deficiencies by providing an invention as further described below.

### SUMMARY

From the foregoing discussion, it should be apparent that a need exists for a distributed, digital ecosystem adapting multiple information and currency-related technological resources.

A computer-implemented method for providing a digital ecosystem is provided, the steps of the method comprising: configuring a plurality of non-transitory computer-readable mediums in a plurality of hardware components on a distributed network comprising, the plurality of hardware components comprising a plurality of cloud server network devices, target network devices, each with one ore more processors and each having wireless communication functionality facilitating data flows between the plurality of hardware components; creating a virtual desktop which can be cast to a remote DPD under the control of a user on a WAN by: adding a plurality of mobile applications to the virtual desktop and saving preference information for each; automating social media functions by enabling social collaboration between a user of the ecosystem and the ecosystem, eliminating the need for direct human interaction or participation in the digital ecosystem; accepting on a first cloud application a digital monetary deposit made using a merchant processing module configured to convert real currency into a digital currency; crediting a consumer profile exclusively-associated with the consumer with a quantity of digital currency directly correlated with the digital monetary deposit in response to the user selecting which virtual currency from a plurality of virtual currencies the user wants credited; transferring a portion of the digital currency to a retailer and debiting the same quantity of digital currency from the account of the consumer; relaying the virtual desktop to a DPD of the consumer using a video stream; and calculating from an open market a value for the digital currency.

The digital currency may be tied directly to the price of the U.S. dollar. Alternatively, the virtual desktop is cast to a user's mobile phone using WebRTC.

The user may manually select the platforms incorporated into the virtual desktop from a portal on a WAN. The user may be incorporated into the virtual ecosystem by saving personally-identifying information for the user in a RDBMS including name, address, photograph, and a plurality of usernames and a plurality of passwords.

The login information may be exclusively associated with the user is saved for use in a single platform in the user's consumer profile in computer-readable memory.

In some embodiments, the digital currency is traded on an open market.

The method may further comprise presenting a user interface (UI) to a customer on a display in logical connectivity with a hardware component including the following: a quantity of digital currency allotted to a customer's account; a list debits, purchases, and transfers of digital currency from the account; an image of the user; a nearest location of a retailer.

The method may further comprise allocating a portion of a plurality differing virtual currencies to the consumer profile.

In some embodiments, the consumer profile comprises a current balance expressed in a plurality of virtual currencies, a dollar equivalent of the current balance expressed in dollars, a distance expressed in miles from a geolocation of the user's DPD to a plurality of merchants, and a map of the area defined by the geolocated points of each of the plurality of merchants and the consumer.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view illustrating an exemplary distributed ecosystem adapting multiple platforms, in accordance with the present invention;

FIG. 2 is a perspective view illustrating the dataflow of an exemplary distributed ecosystem adapting multiple platforms, in accordance with the present invention;

FIG. 3A is a data entity diagram illustrating a customized desktop rendered from an ecosystem and cast to a mobile phone in accordance with the present invention;

FIG. 3B is a data entity diagram illustrating a customized desktop rendered from an ecosystem and cast to a mobile phone in accordance with the present invention;

FIG. 3C is a data entity diagram illustrating a plurality of customized desktops which may be rendered from an ecosystem and cast to a mobile phone in accordance with the present invention;

FIG. 4 is a block diagram illustrating a system, in accordance with the present invention;

FIG. 5A is a flow chart illustrating the steps of a method, in accordance with the present invention;

FIG. 5B is a flow chart illustrating the steps of a method, in accordance with the present invention;

FIG. 5C is a flow chart illustrating the steps of a method, in accordance with the present invention;

FIG. 6A is an illustrative browser displaying an exemplary ecosystem interface adapted to incorporate multiple platforms in accordance with the present invention.

FIG. 6B is an illustrative browser displaying an exemplary ecosystem interface adapted to incorporate multiple platforms in accordance with the present invention.

FIG. 7A is an illustrative browser displaying an exemplary ecosystem interface adapted to incorporate multiple platforms in accordance with the present invention;

FIG. 7B is an illustrative browser displaying an exemplary ecosystem interface adapted to incorporate multiple platforms in accordance with the present invention;

FIG. 8 is a data-entity diagram of an exemplary system and apparatus, in accordance with the present invention;

FIG. 9 is a block diagram of an exemplary system, in accordance with the present invention;

FIG. 10 is a block diagram of an exemplary data in an RDBMS, in accordance with the present invention;

FIG. 11 is a diagram of an exemplary delivery area, in accordance with the present invention; and

FIG. 12 is a block diagram of an exemplary data in an RDBMS, in accordance with the present invention.

Like reference numerals refer to like parts throughout the various views of the drawings. Reference numerals having a common numeric prefix but ending with a letter indicate multiple instances of the same part.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

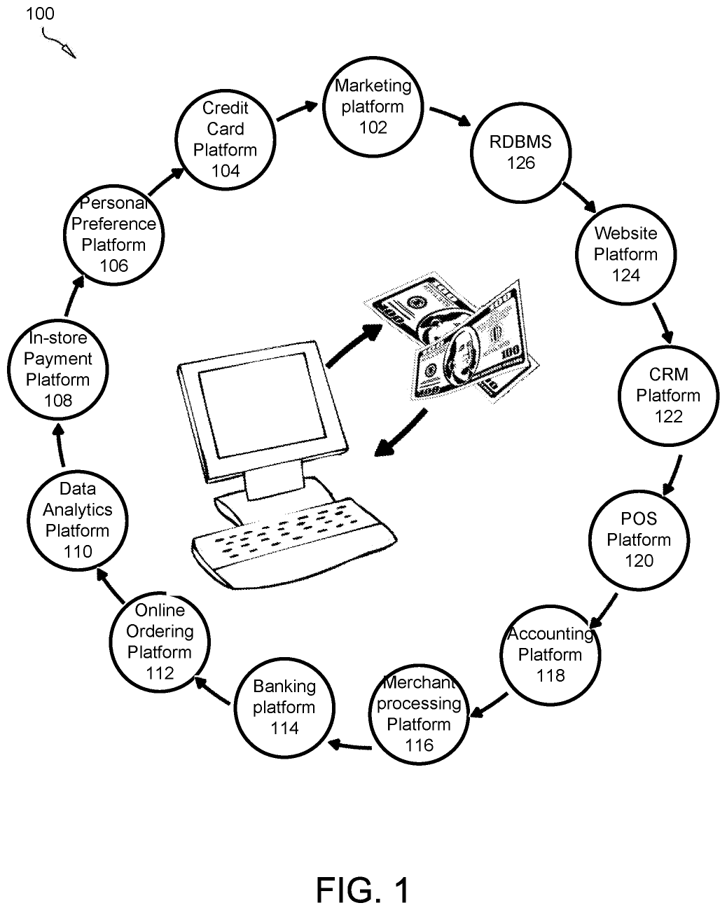

FIG. 1 is a perspective view illustrating an exemplary distributed ecosystem adapting multiple platforms 100, in accordance with the present invention.

It is an object of the present invention to provide a virtual ecosystem which is customized for each individual user and accessible remotely over a LAN (local area network) or WAN (wide area network) such as the Internet from a DPD (data processing device) under the control of a user such as a mobile phone.

The present system 100 is adapted to interconnect a user interfacing with the system 100 with a plurality of platforms 102-126, including an accounting platform 118 such as QuickBooks °, a data analytics 110, an online ordering platform 112, a banking platform 114, a merchant processing platform 116, a point of sale (POS) platform 120, a CRM platform 122, a website platform 124, an RDBMS, a marketing platform 102, a credit card platform 104, a personal preference platform 106, and/or an in-store payment platform 108.

These platforms may all be configured to establish a “handshake,” or interface using an API, with a server and environment exterior to the user's mobile phone. The ecosystem 100 is used to exchange data with these other platforms to render data therefrom for the benefit of the user across a WAN such that the ecosystem 100 is viewable and interfaceable as a dashboard on the user's mobile phone, while emulating a desktop. The functions of platforms incorporated into the ecosystem are executed exteriorly to the user's phone by the ecosystem interfacing with websites handshaking with the ecosystem 100, despite the fact the ecosystem 100 is effectively under operation from without it.

For instance, the ecosystem 100 may directly connect to a bank, such as U.S. Bank using ACH technology. The ecosystem 100 may be adapted to interface with physical POS hardware.

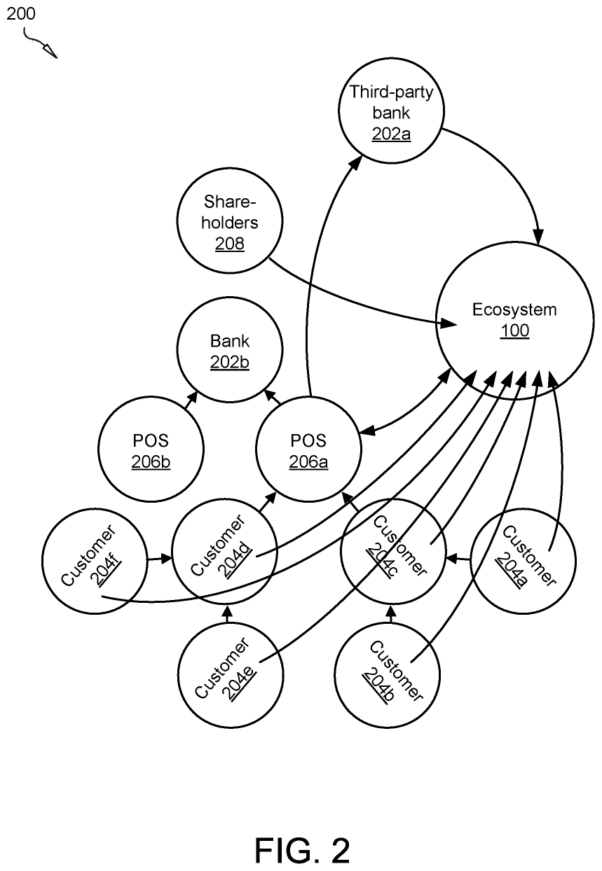

FIG. 2 is a perspective view illustrating the dataflow of an exemplary distributed ecosystem 200 adapting multiple platforms, in accordance with the present invention.

The various embodiments, POS hardware 206 sends information to a third-party bank 202 such as U.S. Bank that a customer 204 (or consumer 204) has made a purchase which in turn sends an encrypted authorization code to the ecosystem 100, 200. The ecosystem 100, 200 records the purchase in historical data 822 and makes funds available for conversion into a virtual currency such as DragonCoin and/or into a cryptocurrency. The purchase is intended to be a purchase of virtual or digital currency. The corporate entity (or provider 810) controlling the ecosystem 100 may be an FDIC or state-chartered bank.

In the system 200, various customers 204a, 204b may be associated in a hierarchal relationship with one or more other customers 204c. Customer 204c may receive a commission in the form of virtual currency when customers 204a, 204b make initial purchases or continued purchases. The customers 204a, 204b may have profiles saved in a tree data structure in the DBMS 804.

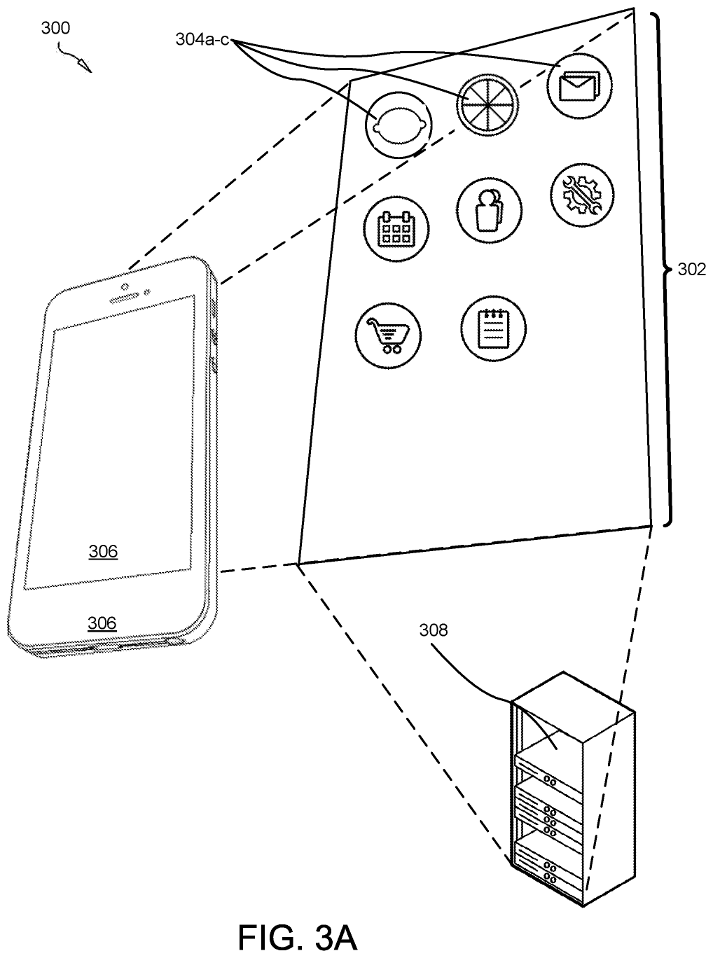

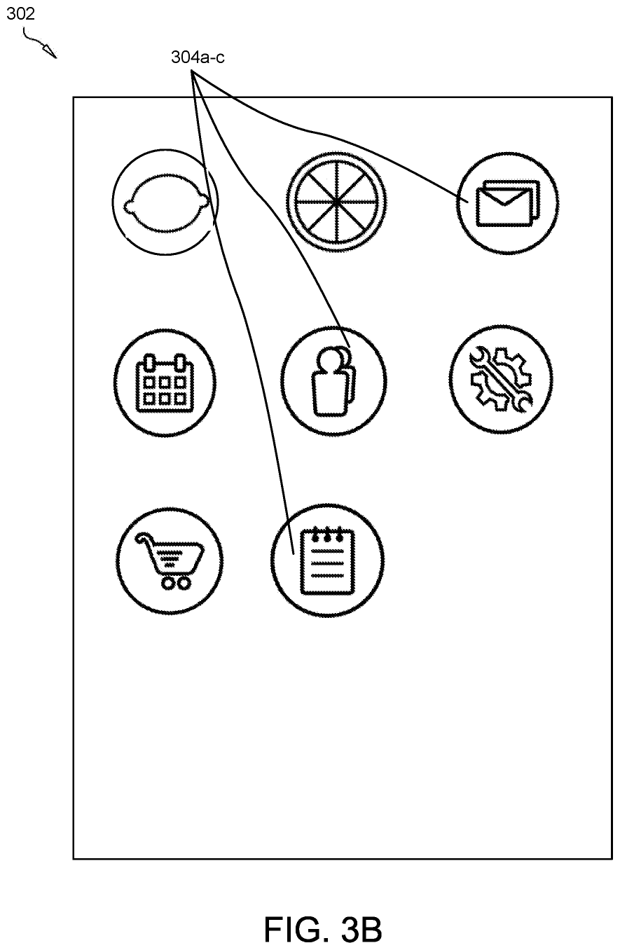

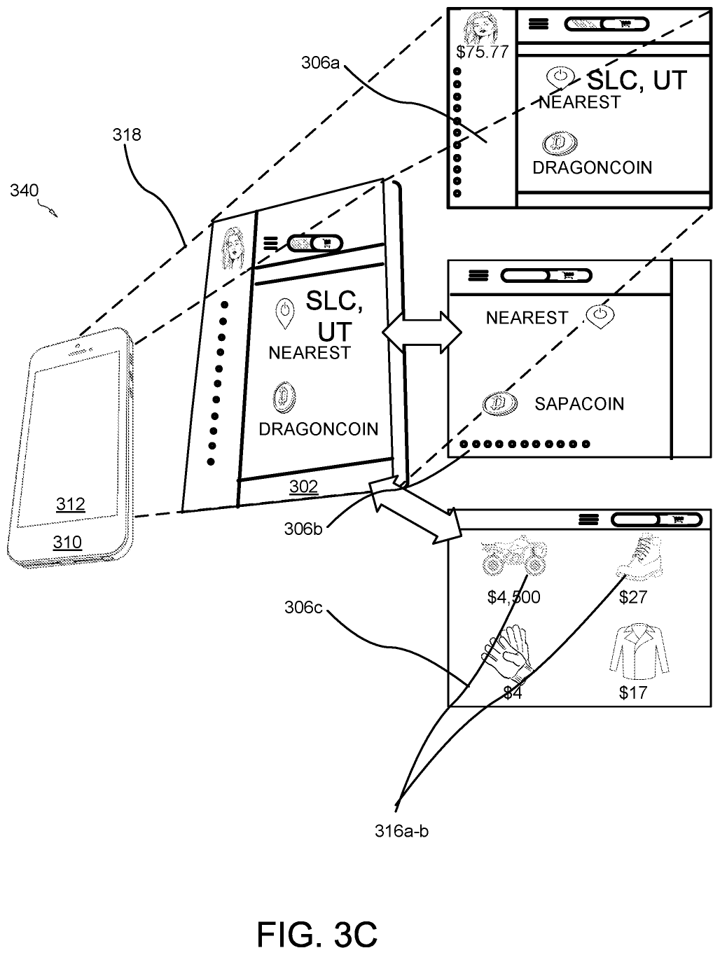

FIG. 3A-3C illustrate data entity diagrams of customized desktops rendered from an ecosystem which may be cast to a mobile phone in accordance with the present invention.

The ecosystem 100, in various embodiments, comprises a set of computer-readable instructions existing in computer readable memory 424 on a server, server cluster 308, or distributed system.

A plurality of applications, represented by icons 304, are loaded into computer readable memory, each application exclusively associated and configured for use by a single user/consumer 204 within a single consumer profile 434. The consumer profile 434 may be encrypted and may also comprise personally-identifiable information within the consumer profile 434 including passwords and username needed for the ecosystem to incorporate the plurality of applications (or platforms) within the ecosystem 100.

In this manner, the server cluster 308 is configured to function as a proxy desktop of the user 204. This remote desktop 302 is cast via a WAN, LAN and/or wireless network 812 to the user's 204 mobile phone 310.

The remote desktop 302 is relayed or cast to the DPD/phone 310 under control of the user 204. In essence, the server session taking place between the ecosystem 100 and each platform is transferred to the user 204. This transfer may take place using WebRTC, peer-to-peer, to send an encoded video stream 312 directly to the user 204. The contents of the ecosystem 100 as arranged in the virtual desktop 302 and associated with the consumer profile 434 of the user 204, for instance, can be reduced to pixels on an and sent or “pushed” over in real time to the user 204. This approach requires access/permission be granted from the ecosystem 100. The video stream 312 reflects the picture of the desktop 302 from the sever 308. Active/passive interaction is achieved between the user 204 and ecosystem 100.

The user 204 may customize the virtual desktop 302 with platforms, or applications, represented by icons 304.

In various embodiments, users 204 are prompted to interact with platforms established by one or more merchants, or retailers 826. These retailers 826 may create their own platforms customized in appearance with which users 204 may interact. As further specified below, the retailers 826 may also create their own virtual currencies to be stored in the user 204 consumer profiles 434. In various embodiments, these platforms 306c are represented by icons 304 on the virtual desktop 302 within the ecosystem 100.

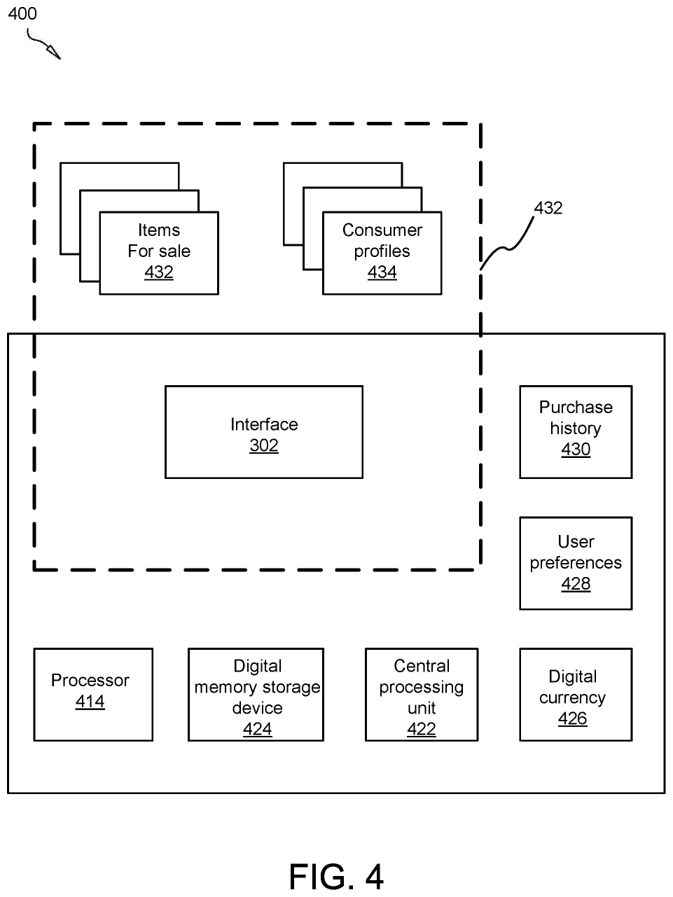

FIG. 4 is a block diagram illustrating a system, in accordance with the present invention.

The ecosystem 400 architecture may comprise any system, apparatus, or computer program running on one or more data processing devices (DPDs), such as a server, computer workstation, router, mainframe computer, or the like. In various embodiments, the DPD comprises one or more processors 414. The processor 414 is a computing device well-known to those in the art and may include an application-specific integrated circuit (“ASIC”).

The system 400 comprises a digital memory storage device such as a RAID, internal or external disk drive, solid state storage device, and the like. In various embodiments, the system 400 comprises a plurality of CPUs 422 (central processing units) which may comprise processors 414.

Within computer readable storage, typically under the control of a DBMS or RDBMS, exists a predetermined quantity of digital currencies 426. In various embodiments, these currencies are created and valued by merchants interacting with the ecosystem 400. The memory 424 may comprises accounts exclusively associated with individual users specifying a quantity of digital currency allocated to that particular user. These accounts, or consumer profiles 434, may contain user preferences 428 and purchase histories 430.

In various embodiments, the DBMS or RDBMS managing the textualized digital files reduces the search request to a query execution plan using hash tables and the like.

These database queries may be generated using various languages including SQL, XPATH, and the like.

Merchant registering with the ecosystem 400 may post items for sale 432 which are stored in computer-readable memory 424.

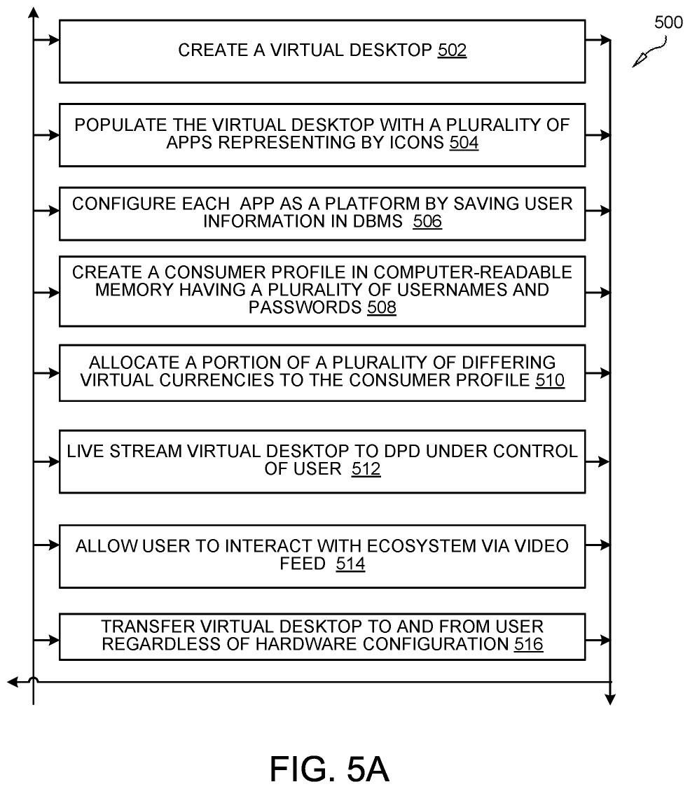

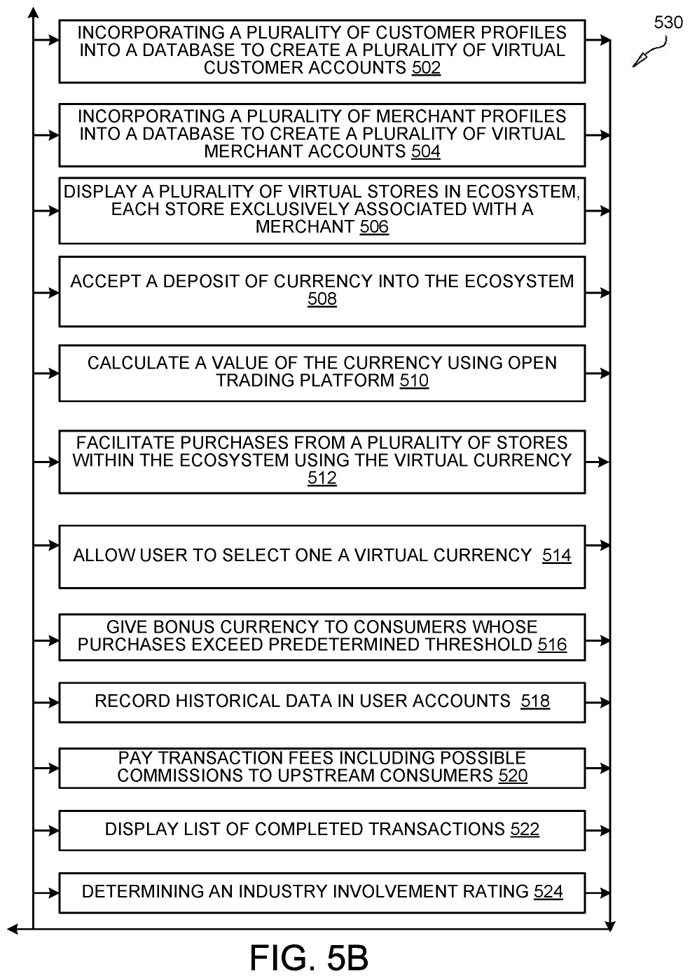

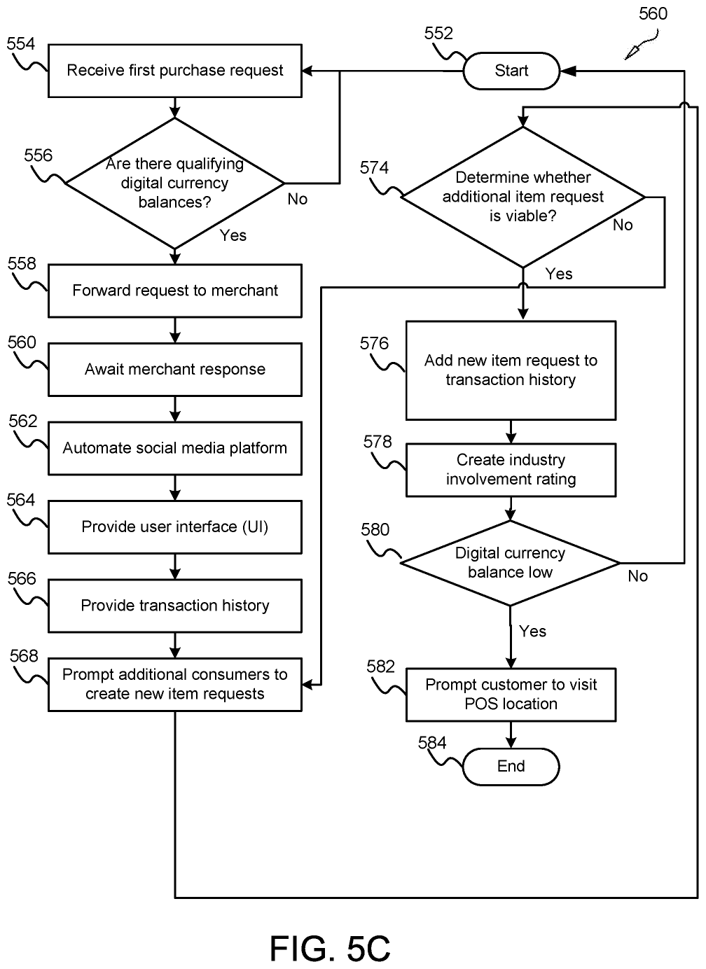

FIGS. 5A-5C are flow charts illustrating the steps of a method, in accordance with the present invention.

The ecosystem 100 comprises the front end logic necessary to receive and transmit bitstreams (i.e., datastreams) including the virtual desktop 302 to the consumer/user 204. The server 308 may include the software, firmware, and hardware necessary to receive and process video streams, including buffers, data unloaders, video unloaders, and the like.

The video stream 318 contains packets linked together by standard tables built when the virtual desktop is converted into a video feed which is live-streamed 512 to the user 204.

In various embodiments, the virtual desktop 302 is populated 504 with platforms 930, or applications, selected by the user 204. Each app, or platform, may be configured 506 independently by the user 204 to be incorporated into the ecosystem 100. For instance, credit card information, user names, and passwords may be saved non on the user's mobile device or DPD, but within the ecosystem 100 in computer-readable memory in heavily-encrypted form.

Various virtual currencies 424 may be allocated 510 to the consumer profile of the user 204.

In this manner, the virtual desktop 302 is accessible via live stream on any device from which the user 204 wishes to access the ecosystem 100. The virtual desktop 302 is thus transferable 516 from one device to another and a user does not need to reinstall apps or reconfigure mobile devices when lost, upgraded or replaced.

In industry involvement rating may be determined 524 by analyzing the transactional history 650 of the user 204 to determine what types of items 316 the user 204 has a habit of purchasing. The ecosystem 100 may be modified to accord premier placement of items 316 which the user 204 is predicted vis-à-vis the industry involvement rating to prospectively prefer. Likewise, merchant 826 may create customized platforms which are incorporated into the ecosystem as well as virtual currencies which the user 204 must acquire to make purchases of item 316 in some embodiments.

In various embodiments, the industry involvement rating is determined to be the sum of each instance of an item being purchased more than once, this sum multiplied by the total number of purchases. In other embodiments, the industry involvement rating is determined to be the sum of each instance of an item being purchased more than once, this sum multiplied by a ration of a specific user's total number of purchases relative to other users. For instance, the specific user for whom the industry involvement rating is being determined may be in the 39^{th} percentile of users for total purchases, in which case the sum would be multiplied by 0.39.

In various embodiments, merchants 826 are afforded control of the name and value of the virtual currency 424 the merchants 826 are defining/creating, including whether said virtual currency may be tied to a standard denomination of hard currency, such as the U.S. dollar. Merchants 826 are also permitted to specify what type of bonuses 516 may be automatically allocated to users 204 who purchase items 316 from the merchant 826. These merchants 826 also specify whether the consumer profile account from which the bonuses are allocated which consumer profile account may be the merchant's 826. The bonuses may be a form of a virtual gift card.

In various embodiments, merchants specify which of the following algorithms are used to determine the quantity of the bonus: (a) the bonus is determined to be the about of virtual currency spent with the merchant by a specific user/consumer over a predetermined time period, such as 180 days, multiplied by the percentage of total purchases said user has made with the merchant; (b) the bonus is determined to be the about of virtual currency spent with the merchant by a specific user/consumer over a predetermined time period, such as 365 days, multiplied by the percentage of total purchases said user has made with the merchant which exceed a predetermined threshold.

In various embodiments, the predetermined threshold is set at a specific amount in dollars or virtual currency, such as $10.00. In other embodiments, the predetermined threshold is set dynamically by a remuneration module 152 to be the average price of one of: (a) all goods sold by said merchant; (b) all goods offered for sale by said merchant; and (c) the price of a typical order comprising a plurality of goods.

The time period may be anywhere from 7 days to 730 days.

In various embodiments, prompting steps such as 582 are realized using SMS messages to the customers and/or email communication through reference to personally-identifying information saved in the consumer profile.

Because the desktop of the user is stored remotely and live-streamed to the user's mobile DPD, the user is relieved of the complicated obligation to constantly reconfigure the user's own mobile phone and operating system, as well as update the same. When the user's DPD is lost or an upgrade purchased, the user need not reinstall applications. In various embodiments, this live stream is realized using a unique codec 972 to compress and decompress either audio and video data packets, or video data packets alone exclusive of audiographic information. In some embodiments, only video data is compressed by the codec 972 to save the bandwidth necessary to stream audio also.

Another object of the present invention to store personally-identifying information in one central location, where said information can be shared with all of the applications on the desktop. This personally-identifying information is used to populate fields stored within the consumer profile.

The codec 972 may use a modified version of Secure Real-time Transport Protocol (SRTP) to compress and stream the desktop. The codec 972 may be modified to eliminate use of Advanced Encryption Standard (AES) as an encryption cipher, streaming the data unencrypted. Currently, a NULL cipher is not permitted by accepted SRTP.

A user may specify a security level for video streaming. For instance, a user may specify a level of one, two, three or four. In level one, the payload of RTP packets is not encrypted. In level two, the payload of RTP packets is encrypted. In level three, the payload of RTP packets and the RTP extension headers are encrypted. In level four, the packets are double-encrypted after clearing references to certain colors or text from the audio stream. For instance, text formed of character strings containing the names of applications on the desktop may be scrubbed by a personal preference platform 106 configured to search for the names of applications installed by the user.

In various embodiments, a two-way WebRTC channel is established between the user's mobile phone and the desktop, wherein streaming video is transmitted to the desktop of received SMS messages by the user as well as received emails, such that the desktop can automatically authenticate said user when credentialling itself with applications incorporated/installed on the desktop.

In various embodiments, historical purchasing data is stored/recorded 518 in user accounts in exclusive association with the consumer profile of the user. This data may comprise a timestamp indicated the date and time of purchase, items purchased, a merchant name, costs, bonuses derived by the user on said purchases, and historical tracking the user's industry involvement rating expressed as a float.

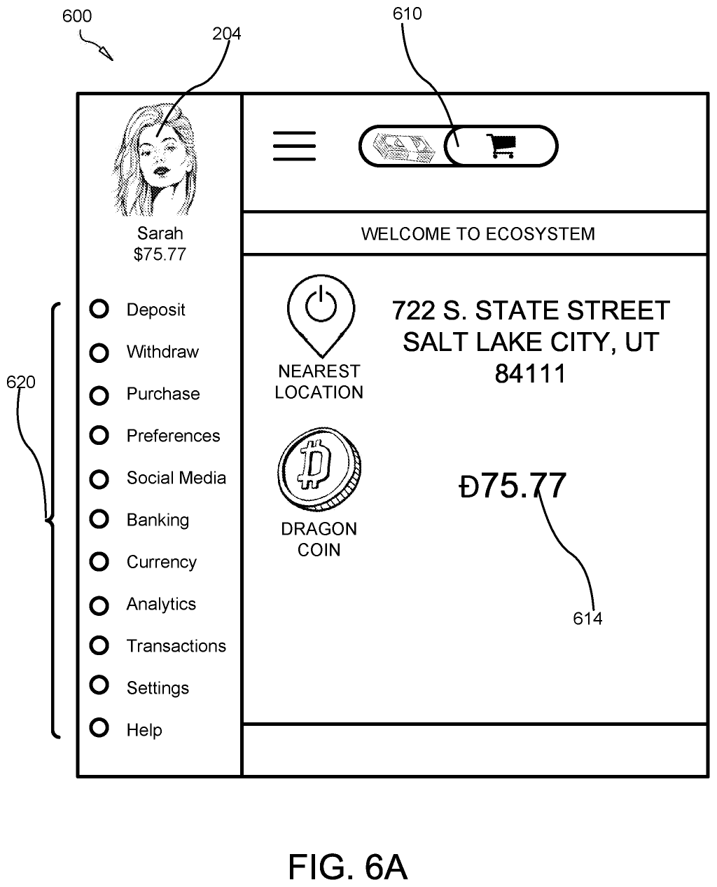

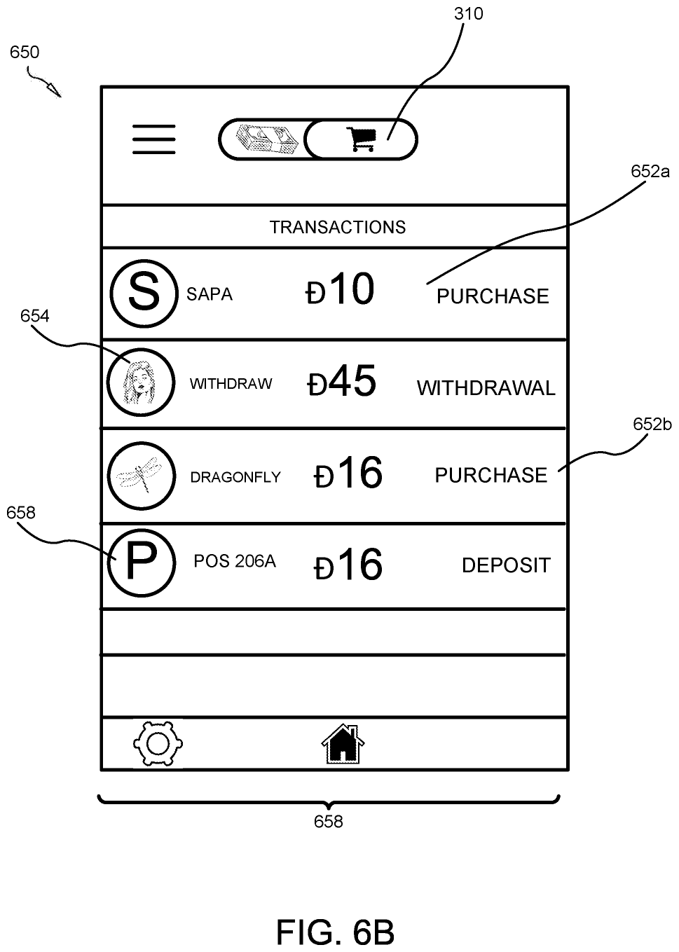

FIG. 6A is an illustrative browser displaying an exemplary ecosystem interface adapted to incorporate multiple platforms in accordance with the present invention.

The dashboard, or desktop 302, shown in FIG. 6A comprises a video feed 310 relayed from the ecosystem 100. In the shown embodiment, a user is viewing a banking platform 114 within the ecosystem 100.

In some embodiments, the server 308 collects payment from a consumer 204 after a purchase is made from a merchant 826 (or retailer 826), then remunerates the merchant 126 in accordance with a predetermined payment schedule mutually agreed upon by the provider 810 and the merchant 826. The ecosystem 100 is managed by the provider 810.

The consumer 204 may comprise any person, company, or organization that is potentially a customer of a merchant 826. Each consumer 204 and provider 810 are incorporated into a marketing network comprising other consumers 204 and merchants 826 who have registered with the provider 810. For the purposes of this disclosure, the terms “incorporate” and “incorporation” denote the act of formally enrolling by a consumer 204 and/or a merchant 826 into the ecosystem 100. The merchant 826 and consumer 204 may be associated through social media or have prior business relationships.

Consumers 204 and merchants 826 become incorporated when they create accounts with the technology provider 810 by uploading personal identifying information, including one or more of: an address, an email address, a telephone number, and banking information. In typical embodiments, the registration takes place via a browser, but may also be sent to the provider 810 using programs well-known to those of skill in the art, such as Chrome, FireFox, Microsoft Outlook, Thunderbird, Yahoo! Mail, and the like. In other embodiments, the consumers 204 and providers 810 are incorporated by receiving personal 401 information via an API from a social media provider such as Google®, Facebook®, Twitter®, Instagram®, Snapchat®, or other social media providers known to those of skill in the art.

Like the consumers 512, the merchants 826 may comprise any person, company, or organization that is potentially a merchant of another person, company, or organization. The consumer product 316a-b may comprise any valuable item which can be purchased, tangible, or intangible, which are for sale by a merchant 826. Examples of consumer products may include food, housing, medicine, and the like; or boots, gloves, a coat, or ATV as shown.

The merchant 826 may comprise any system, apparatus, or computer program running on one or more data processing devices (DPDs), such as a server, computer workstation, router, mainframe computer, or the like. In various embodiments, the DPD comprises one or more processors. The processor is a computing device well-known to those in the art and may include an application-specific integrated circuit (“ASIC”).

Consumer item requests 820 are stored in persistent storage 906. The merchant processor 919 is known to those of skill in the art, and may comprise a processor such as Elavon®, PayPal®, or the like.

When payments are accepted from a consumer 204, the product being purchased is the virtual currency 424. This virtual currency is then used to exchange with merchants 826 for other products 316 or services, but it is not the products 316 which are being purchases initially when credit card transactions are made.

In various embodiments, the technology provider managing the ecosystem 100 may comprise, or be in logical communication with, an SMS gateway provider which relays short messages between the provider and/or one or more consumers 204 and merchants 826.

FIG. 6A is an illustrative browser displaying an exemplary ecosystem interface 600 adapted to incorporate multiple platforms in accordance with the present invention.

A photograph of the user 204 is displayed, along with virtual controls 520, 510. The user 204 is given the option of selecting from the virtual controls shown in the left navigation bar in exemplary format.

The interface displays at quantity of virtual coin 614 allocated to the user 204. This virtual coin 614 is created by a merchant 826. Multiple quantities of different virtual currencies created by differing merchants may be shown in the banking platform 114.

FIG. 6B is an illustrative browser displaying an exemplary ecosystem interface 650 adapted to incorporate multiple platforms in accordance with the present invention.

The interface 650 shows the transaction history of the consumer 204. The transaction history is arrived to when “transactions” is selected from the virtual controls 620 by way of example. As shown, purchases 652 are displayed in a queue or stack 658, which may quantify the price of a purchase or transaction 652. Withdrawal 654 are also shown, as deposits 658. Each transaction shows the icon of a merchant 826 with whom the consumer 204 transacted and a name of the merchant 826 incorporated with the ecosystem 100.

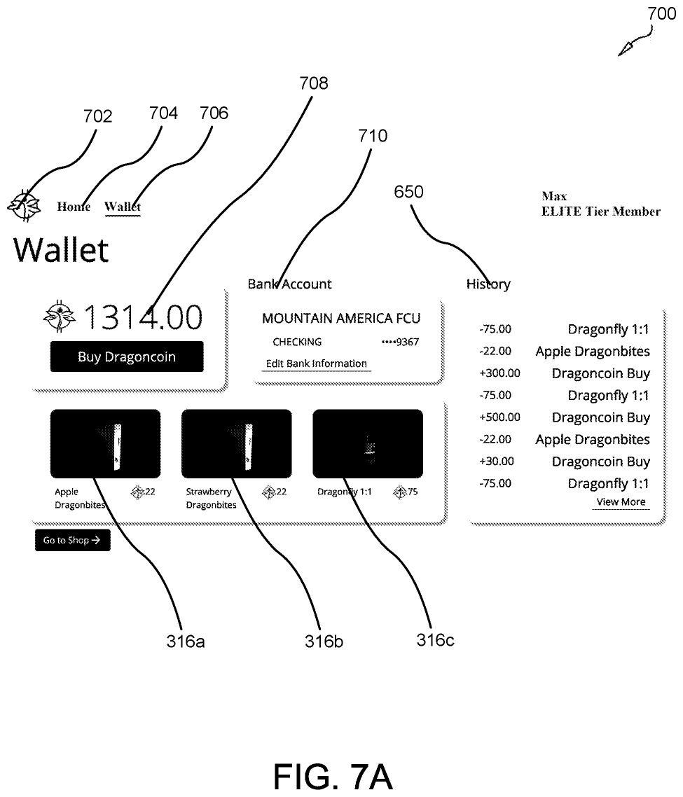

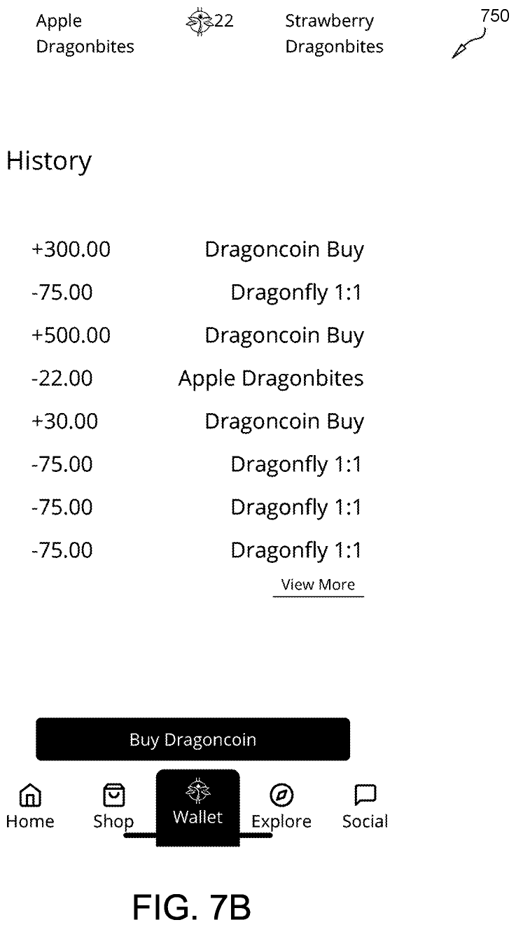

FIG. 7A is an illustrative browser displaying an exemplary ecosystem interface 700 adapted to incorporate multiple platforms in accordance with the present invention.

An icon 702 of the merchant 826 is displayed in this example in the top left of the interface 700. Virtual controls 704, 706 are also displayed in the top navigation bar. In this version of the ecosystem 100, the banking module 710 is displayed as is the transaction history 650. The virtual currency 614 used in this embodiment is Dragoncoin. The quantity of Dragoncoin allocated to user 204 is indicated at 708.

FIG. 7B is an illustrative browser displaying an exemplary ecosystem interface adapted to incorporate multiple platforms in accordance with the present invention.

The merchant processing platform 116 may appear as shown in some embodiments.

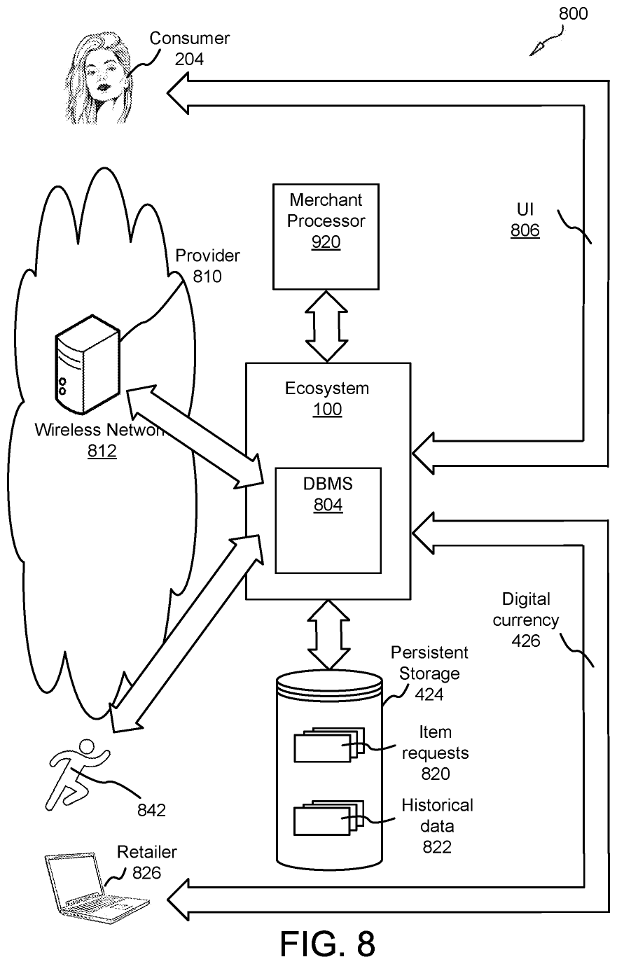

FIG. 8 is a data-entity diagram of an exemplary system and apparatus, in accordance with the present invention.

The system 800 comprises a server operating under a technology provider 810, a database management system (DBMS) 804, persistent storage 324, stored item requests 820, stored historical data 822, a wireless network 812, consumers 204, merchants 826, a user interface (UI) 806 and a digital currency 824.

Typically, the server comprises one or more central processing units executing software and/or firmware to control and manage the other components within the system 800. In one embodiment, the server comprises hardware and/or software more commonly referred to as a Multiple Virtual Storage (MVS), OS/390, zSeries/Operating System (z/OS), UNIX, Linux, or Windows.

The server may comprise a server cluster with firewalls, load balancer, and database servers having Apache® and/or other software applications well-known to those of skill in the art. The server, in the shown embodiment, comprises a database management system (DBMS) 804 or relational database management system (RDBMS), such as Oracle, MySQL, SQL, FireBird, IBM DB2®, or the like.

The server is in logical communication with one or more consumers 512 and one or more merchants 826 (i.e., runners) through a networked environment 912, such as local area network (LAN) or wide area network (WAN). The server 902 may communicate with consumers 918 and/or runners/providers 914, sending queues, consumer requests 920, and commercial offerings 922, using variations of the Simple Mail Transfer Protocol (SMTP), Internet Message Access Protocol (IMAP), Post Office Protocol (POP), or other protocols well-known to those of skill in the art.

In the present invention, the server routes information between consumers 204 and the ecosystem 100. The server is in logical communication via the Internet 812 with the cellular phones of consumers 204, or through other personal DPDs such as laptops, Palm Pilots®, digital cameras, and the like.

In the present invention, as further described in detail above and below, consumers 204 create item or purchase requests 920 on their computers which are then relayed to merchants 824. In alternative embodiments, the consumer requests are created by the providers. These purchase requests 820 comprise information about retail products 316 which the consumer 204 would like purchased. The server facilitates a real-time negotiation between the consumer 204 and the merchant via a WAN such as the Internet.

In some embodiments, the server collects payment from a consumer 918 after the consumer good(s) are delivered, then remunerates the providers 914 in accordance with a predetermined payment schedule mutually agreed upon by the provider 914 and one or more of: an organization managing a network interface (a technology provider) and a consumer 204.

Item requests 920 are stored in persistent storage 806. The merchant processor 826 is known to those of skill in the art, and may comprise a processor such as Elavon®, PayPal®, Authorize.net or the like.

In various embodiments, the server may comprise, or be in logical communication with, an SMS gateway provider which relays short messages between the ecosystem 900 and/or one or more consumers 204.

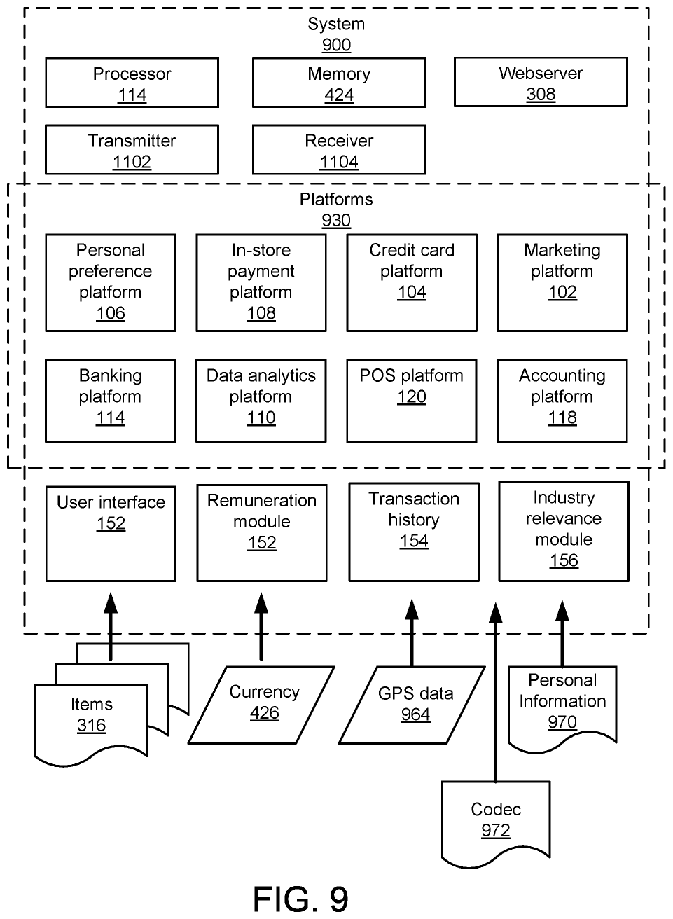

FIG. 9 is a block diagram of an exemplary system, in accordance with the present invention.

The system 900 comprises a webserver 308, a transmitter 1102, a receiver 1104, and a plurality of platforms incorporated into the ecosystem 900 as shown. The personal preference platform is configured to accept personally identifying information from the consumer 204, including name, photograph, banking information, address, and the like. The in-store payment platform 108 is configured to allow a user 204 to make payment for purchased good 316 using virtual currency 424. The credit card platform 104 is configured to allow consumers 204 to make credit card payments which are converted to one or more virtual currencies 424. The marketing platform 102 is configured to allow a merchant 826 to manage marketing campaigns, including on social media and search engines.

The banking platform 114 is configured to allow a user 204 to interface with a bank, such as U.S. Bank® or Chase®, and manage banking operations. The data analytics platform 110 is configured to allow a user to view reports, summaries and statistics of marketing effectiveness. The remuneration module 152 is configured to allow a user to remunerate another consumer 204 outside of a merchant platform with virtual currency. All of these modules are further described above and below in relation to other methods, processes and apparati.

Various types of data are input into the system 900 including items 316, virtual currency 426, GPS data 964 of the consumer 204, and personal information from the consumer 204 to the personal preference platform 106.

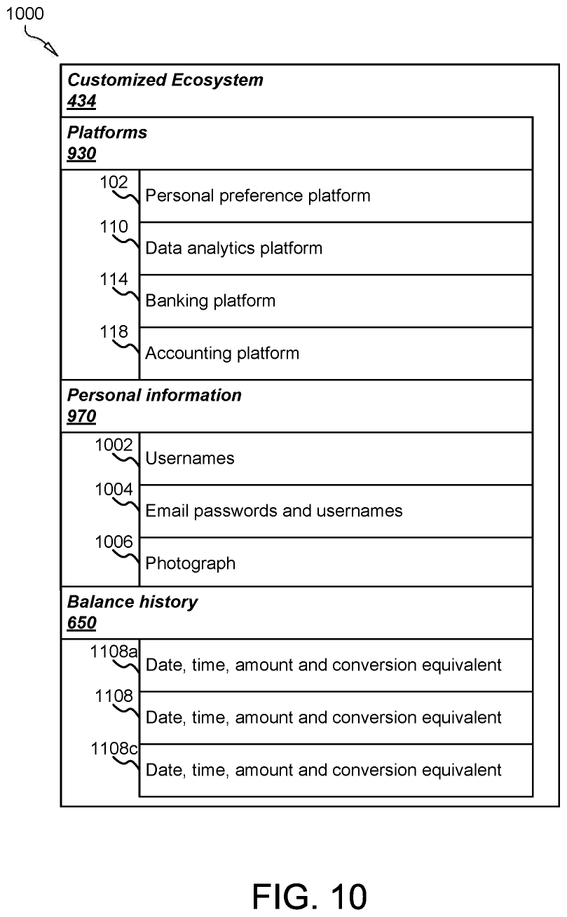

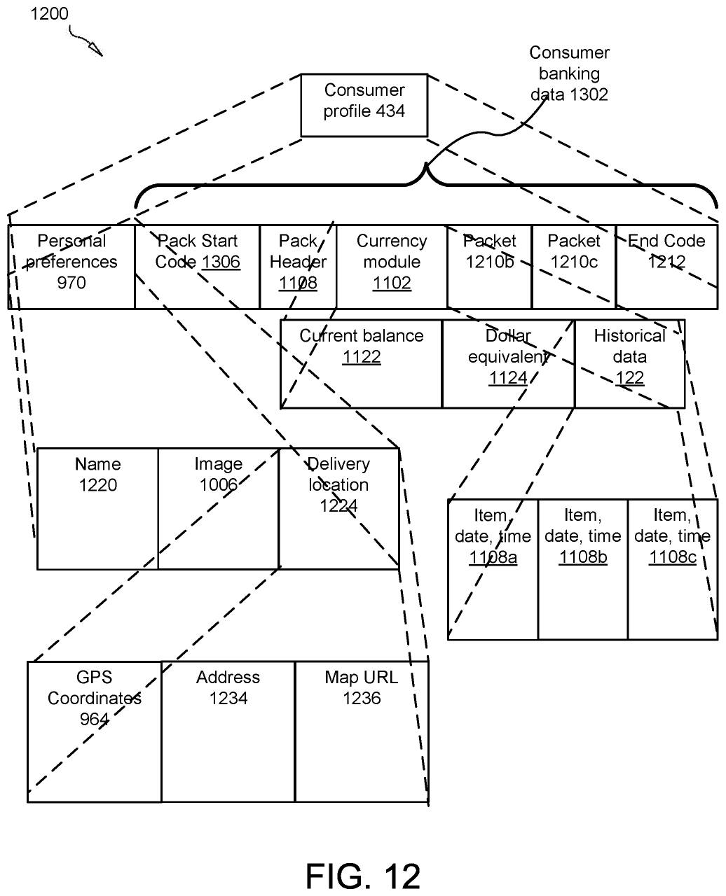

FIGS. 10 and 12 is a block diagram of an exemplary consumer profile 434, in accordance with the present invention.

In various embodiments, the consumer profile 434, or customized ecosystem, comprises blocks of data as shown, including the platforms 930 shown, as well as the personal information 970 exclusively associated with a consumer 204.

The personal preferences 970 may include a delivery location 1224 which delivery location may include the GPS coordinates 964. The consumer profile 434 may be organized as a tree data structure 1200 as shown, which the data in each shown square comprising a node.

In some embodiments of the personal preference platform, a user is prompted to, and does submit, login information for a plurality of email accounts such that the system 900 may receive authentication codes automatically without manual relay from the user when accessing account information for the user vis-à-vis third-party applications incorporated into the desktop or in logical communication therewith.

In various embodiments, an application is installed on the user's DPD which is given permission to access SMS messages on the user's DPD such that authentication codes sent via text messages may be automatically relayed to the desktop via the second WebRTC channel or other video-conferencing or data capture means.

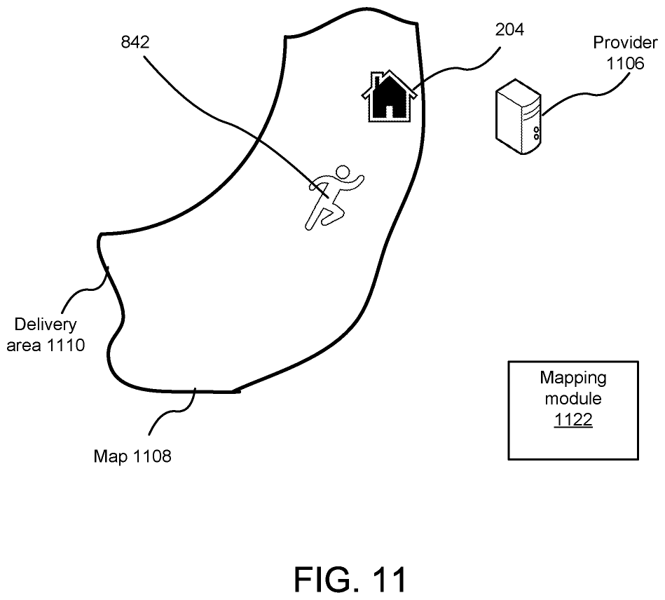

FIG. 11 is a diagram of an exemplary delivery area, in accordance with the present invention.

In various embodiments, items 316 are delivered if ordered from a consumer 204 whose GPS data 964 indicates the consumer 204 is located only within a predetermined delivery area 1110, which may comprise a city, state, franchise area or legal jurisdiction.

This can be performed through a GPS, Google Maps™, or other location technologies and APIs known in the art.

The system 1200 may comprise a mapping module 1122 configured to map a map 1108 onto the delivery location of the consumer 204. The mapping module may also draw a delivery area 1110 on a map which is drawn between the location points of a plurality of merchants in closest proximity to the user, and/or between the location point of the consumer as expressed in the GPS data 964 and the merchants.

FIG. 12 illustrates a block diagram representing an exemplary consumer profile 1200. The consumer profile 1200 may comprise a current balance 1122 expressed in a plurality of virtual currencies, a dollar equivalent of the current balance expressed in dollars, and a distance expressed in miles from a geolocation of the user's DPD to a plurality of merchants.

In various embodiments, the marketing platform of the system 900 is configured to received GPS data 964 from a user's phone and to calculate a distance from the user to all of the merchants having accounts registered with the system 900. In various embodiments, the distances between the user and the three closest merchants is stored in the consumer profile 1200.

The present invention has been developed in response to the present state of the art, and in particular, in response to the problems and needs in the art that have not yet been fully solved by currently available marketing systems that collect and use consumer personality traits. Accordingly, the present invention has been developed to provide a method and system for predictive application of virtual personality renderings that overcome many or all the above-discussed shortcomings in the art.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer-implemented method for providing a digital ecosystem, the steps of the method comprising:
configuring a plurality of non-transitory computer-readable mediums in a plurality of hardware components on a distributed network comprising, the plurality of hardware components comprising a plurality of cloud server network devices, target network devices, each with one or more processors and each having wireless communication functionality facilitating data flows between the plurality of hardware components;
creating a virtual desktop which can be cast to a remote DPD under the control of a user on a WAN by:
adding a plurality of mobile applications to the virtual desktop and saving preference information for each;
automating social media functions by enabling social collaboration between a user of the ecosystem and the ecosystem, eliminating the need for direct human interaction or participation in the digital ecosystem;
accepting on a first cloud application a digital monetary deposit made using a merchant processing module configured to convert real currency into a digital currency;
crediting a consumer profile exclusively-associated with the consumer with a quantity of digital currency directly correlated with the digital monetary deposit in response to the user selecting which virtual currency from a plurality of virtual currencies the user wants credited;
transferring a portion of the digital currency to a retailer and debiting the same quantity of digital currency from the account of the consumer;
relaying the virtual desktop to a DPD of the consumer using a video stream; and
calculating from an open market a value for the digital currency.

2. The method of claim 1, wherein the digital currency is tied directly to the price of the U.S. dollar.

3. The method of claim 1, wherein the virtual desktop is cast to a user's mobile phone using WebRTC.

4. The method of claim 3, wherein the WebRTC is realized using video data packets not comprising audiographic information.

5. The method of claim 1, wherein the user manually selects the platforms incorporated into the virtual desktop from a portal on a WAN.

6. The method of claim 1, wherein the user is incorporated into the virtual ecosystem by saving personally-identifying information exclusively associated with the user in an RDBMS including name, address, photograph, geolocation expressed in GPS coordinates as floats, and a plurality of usernames and a plurality of passwords.

7. The method of claim 5, wherein the personally-identifying information is stored in a consumer profile which comprises a tree data structure.

8. The method of claim 7, wherein the personally-identifying information includes login information for a plurality of email accounts.

9. The method of claim 1, wherein login information exclusively associated with the user is saved for use in a single platform in the user's consumer profile in computer-readable memory.

10. The method of claim 1, wherein the digital currency is traded on an open market.

11. The method of claim 1, further comprising presenting a user interface (UI) to a customer on a display in logical connectivity with a hardware component including the following:
a quantity of digital currency allotted to a customer's account;
a list debits, purchases, and transfers of digital currency from the account;
an image of the user; and
a nearest location of a retailer.

12. The method of claim 1, further comprising allocating a portion of a plurality differing virtual currencies to the consumer profile.

13. The method of claim 1, wherein the consumer profile comprises a current balance expressed in a plurality of virtual currencies, a dollar equivalent of the current balance expressed in dollars, a distance expressed in miles from a geolocation of the user's DPD to a plurality of merchants, and a map of the area defined by the geolocated points of each of the plurality of merchants and the consumer.
